(19) United States
(12) Patent Application Publication
(10) Pub. No.: US 2010/0194787 A1
(43) Pub. Date: Aug. 5, 2010

(54) PLASMA DISPLAY PANEL DISPLAY APPARATUS

(76) Inventors: Toshihiro TSUTSUI, Inagi (JP); Hidenao Kubota, Yokohama (JP); Hirohito Kuriyama, Yokohama (JP); Yuzo Nishinaka, Chigasaki (JP)

Correspondence Address: MCDERMOTT WILL & EMERY LLP, 600 13TH STREET, N.W., WASHINGTON, DC, 20005-3096, US

(21) Appl. No.: 12/614,701

(22) Filed: Nov. 9, 2009

(30) Foreign Application Priority Data
Feb. 2, 2009 (JP) 2009-021097

(51) Int. Cl. G09G 5/10; G06F 3/038

(52) U.S. Cl. 345/690; 345/212; 345/63

(57) ABSTRACT

White noise images and white noise-like pattern images are discerned by making use of the fact that the address current is increased when such an image is entered and detecting the address current by an address current detection circuit. When the detected address current exceeds a given value α and persists for a given period of time, a CPU controls a contrast control circuit to lower the contrast of the video signal, thus reducing the power consumption of an address driver circuit.

### INCORPORATION BY REFERENCE

The present application claims priority from Japanese application JP 2009-021097 filed on Feb. 2, 2009, the content of which is hereby incorporated by reference into this application.

### BACKGROUND OF THE INVENTION

The present invention relates to a plasma display panel display apparatus using a plasma display panel.

A plasma display panel (PDP) display apparatus (hereinafter may be abbreviated a PDP display apparatus) using a plasma display panel (PDP) is available as one type of image display device using a self-luminous display panel that is thin and capable of displaying TV images and other images.

A PDP has a plurality of discharge cells each having a discharge space corresponding to each pixel (subpixel) of R, G, and B, as described, for example, in JP-A-2002-366088 and JP-A-2003-029699. Desired discharge cells are selected by applying an addressing voltage between address electrodes and Y electrodes corresponding to the desired ones of the discharge cells to be activated to emit light by a gas discharge. Wall charge is formed on the discharge cells. An operation for selecting such desired discharge cells is hereinafter referred to as the addressing operation.

After the addressing operation, discharge-sustaining pulses are applied to the X- and Y-electrodes. The addressed discharge cells are activated to emit light by a gas discharge.

A picture is displayed by executing this sequence of operations for each subfield obtained by dividing one frame/field of video signal by a given number (e.g., 8 to more than 10).

### SUMMARY OF THE INVENTION

As described above, in the PDP, the addressing operation and discharging operation are repeatedly performed. Therefore, the panel itself and electric circuitry including the address driver circuit and X/Y sustaining circuits for executing those operations generate relatively large amounts of heat.

Our discussions have showed that the power consumption of a circuit (hereinafter referred to as the address driver circuit) for executing the addressing operation increases and thus the amount of generated heat increases when certain pictures are displayed on the PDP.

Such a certain picture contains many relatively small, high-brightness objects (hereinafter referred to as tiny bright spots), for example, against a relatively dark background (e.g., a black background). One example of such certain pictures is a so-called white noise image appearing, for example, in cases where no broadcasting signal can be received. Another is a picture of a broadcast program scene of a soccer stand in which bright spots (such as faces and cloths of audience members) and dark spots are minutely mixed. This picture is hereinafter referred to as a white noise-like image to discriminate it from a white noise image. These are hereinafter collectively referred to as “certain pattern images.”

The address driver circuit has switching devices. When an addressing voltage is output, the corresponding switching device is turned on, for example. When the voltage is not output, the switching device is kept off, for example. As an example, when a certain pattern image having many tiny white bright spots against a black background is displayed, the address driver circuit turns on and off the switching devices at high frequency in order to apply an addressing voltage to discharge cells corresponding to the multiple tiny bright spots during each subfield period, and repeats this sequence of operations over one video field/frame.

Therefore, in these cases, the number of switching operations performed by the address driver circuit is increased and a larger amount of switching loss occurs compared with cases where other images are displayed. As a result, an electrical current (hereinafter referred to as the address current) flowing through the address driver circuit increases, thus increasing the power consumption and the amount of generated heat.

Accordingly, where certain pattern images are displayed, the temperature of the outermost surface of the PDP on the viewer side near the address driver circuit may exceed a given temperature, i.e., tangibly hot (e.g., 60° C.) in some cases.

The present invention has been made in view of the foregoing problem. The invention is intended to provide a technique of reducing the power consumption of a PDP or suppressing rise of the temperature even when certain pattern images such as white noise images and white noise-like pattern images are displayed.

The present invention makes use of the fact that the address current of an address driver circuit is increased when a white noise-like pattern image is entered. That is, the invention is characterized in that the address current is detected and that the address current is so controlled that it is reduced when the detected address current continues to be in excess of a given value for a given period of time.

The address current can be reduced, for example, by reducing the contrast of the input video signal, increasing the black level of the input video signal, or reducing the power supply voltage of the address driver circuit.

According to this configuration, during processing of the video signal, the number of address switching operations per field/frame is reduced to thereby reduce the address current and power consumption by controlling the contrast and/or black level such that white and black levels indicated by the video signal outputted to the PDP are changed, for example, to white and gray levels, gray and black levels, or different gray levels.

According to the present invention, when a certain pattern image such as a white noise image or white noise-like pattern image is entered, the address current is reduced. Consequently, the power consumption of the address driver circuit decreases. Thus, increases in the amount of generated heat can be suppressed.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a PDP display apparatus according to one embodiment of the present invention;

FIG. 2 is a table illustrating the relationships among address current, addressing voltage, and power consumption for each different input video signal pattern;

FIG. 3 is a graph illustrating rise of the temperature of the outermost surface of a PDP on the viewer side when a white noise image is applied;

FIG. 4 is a diagram illustrating contrast control patterns;

FIG. 5 is a table illustrating variations in address current caused by application of different input video signal patterns during contrast control;

FIG. 6 is a diagram illustrating the relationship between a given value α used in providing contrast control and another given value α′ at which the contrast control is ceased;

FIG. 7 is a graph illustrating a pattern in which the black level varies during the execution of contrast control;

FIG. 8 shows one example of white noise-like pattern image; and

FIGS. 9A-9C show an outline of a PDP structure and one example of a switching operation.

### DETAILED DESCRIPTION OF THE INVENTION

Embodiments of the present invention are hereinafter described with reference to the drawings. First, a phenomenon in which the temperature of an address driver circuit is elevated by a certain video pattern is described.

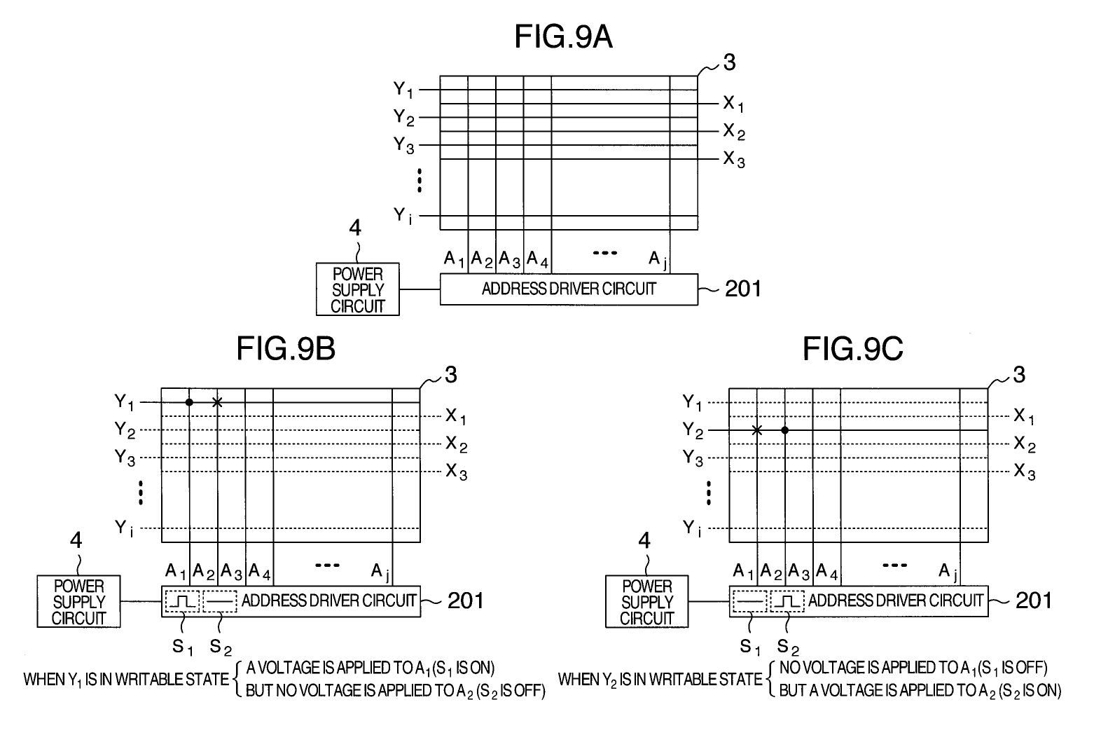

FIGS. 9A-9C schematically show the electrode structure of a PDP and an addressing operation. As shown in FIG. 9A, the PDP, indicated by reference numeral 3, has Y electrodes Yᵢ and X electrodes Xᵢ extending horizontally (laterally). The electrodes act as discharge electrodes and are formed in a corresponding manner to individual rows. Address electrodes Aⱼ are formed such that they intersect the Y electrodes Yᵢ and X electrodes Xᵢ in a corresponding manner to individual columns (lines). i and j are integers equal to or greater than 1. If it is assumed that the PDP 3 has 1,920×1,080 pixels, i assumes values from 1 to 1,080. j assumes values from 1 to 1,920. In practice, each pixel is made up of subpixels of the three colors R, G, and B. An address electrode is formed for each subpixel. Therefore, j can assume values up to 5,760 (1,920×3). In FIGS. 9A-9C, for the sake of simplicity of illustration, only one address electrode is shown for each pixel. The Y electrodes Yᵢ, X electrodes Xᵢ, and address electrodes Aⱼ are shown only partially.

An address driver circuit 201 is connected with the lower ends of the address electrodes Aⱼ. During an addressing operation, the address driver circuit applies an addressing voltage to each address electrode Aⱼ. The address driver circuit 201 is connected with a power supply circuit 4 for supplying electric power to it to generate the addressing voltage. Plural switching devices (not shown in FIG. 9A) connected with the address electrodes Aⱼ are included in the address driver circuit. For instance, when the addressing voltage is applied to a corresponding one of the address electrodes Aⱼ, each corresponding switching device is turned on. When the voltage is not applied, the switching device is kept off. At each intersection point between the Y electrodes Yᵢ, X electrodes Xᵢ, and address electrodes Aⱼ, a discharge cell having a discharge space including a phosphor of any one color of R, G, and B is formed. A rare gas such as helium, neon, or xenon is sealed in the discharge space. For the sake of simplicity of illustration, the discharge cell is not shown herein. A Y sustain circuit (not shown for simplicity) for applying a sustain pulse to the Y electrodes Yᵢ is connected, for example, with the left ends of the Y electrodes Yᵢ. An X sustain circuit (not shown for simplicity) for applying a sustain pulse to the X electrodes Xᵢ is connected, for example, with the right ends of the X electrodes Xᵢ.

When it is desired to induce a gas discharge emission in a desired discharge cell, a Y electrode corresponding to the desired discharge cell is put into a writable state based on the video signal. Then, an addressing operation is performed to apply an addressing voltage to the corresponding Y electrode and address electrode Aⱼ to select the desired discharge cell. A wall charge is established on the discharge cell. Subsequently, a discharge-sustaining pulse (sustain pulse) is applied to the X electrode Xᵢ and Y electrode Yᵢ to produce an electrical discharge in the rare gas within the discharge cell selected by the addressing operation. This produces ultraviolet radiation, which in turn excites the phosphor in the discharge cell. Consequently, the discharge cell is activated to emit light. Thereafter, an erase step for removing the wall charge on the emitting discharge cell is performed. An operation consisting of these steps is performed for each of the subfields obtained by dividing 1 frame/field of the video signal by a given number (e.g., 8 to more than 10).

Our discussions have revealed that in the PDP of this construction, in a case where a certain pattern image such as a white noise image or white noise-like pattern image containing many tiny bright spots against a relatively dark (e.g., dark) background is displayed, a phenomenon in which the power consumption of the address driver circuit increases and the temperature rises may occur. The principle of the phenomenon is described below by referring still to FIGS. 9B-9C.

In a case where a certain pattern image is displayed on the PDP 3 of the construction described above, it is assumed that the discharge cell at the intersection of the Y electrode Y₁ and address electrode A₁ and the discharge cell at the intersection of the Y electrode Y₂ and address electrode A₂ are activated to emit light during some subfield period and that the discharge cell at the interaction of the Y electrode Y₁ and the address electrode A₂ and the discharge cell at the interaction of the Y electrode Y₂ and the address electrode A₁ are unlit. An addressing operation performed under this condition is described by referring to FIGS. 9B and 9C, where indicates a discharge cell activated to emit light, while x indicates a discharge cell not activated.

The addressing operation is performed from the first line to the final line in succession in the vertical direction. Therefore, at first, as shown in FIG. 9B, the Y electrode Y₁ on the first line is brought to a writable state. A switching device S₁ in the address driver circuit 201 connected with the address electrode A₁ is turned on. Consequently, an addressing voltage, for example, at H level as shown is applied to the address electrode A₁. At this time, a switching device S₂ connected with the address electrode A₂ is turned off. An addressing voltage from the switching device S₂ goes low (L). That is, no addressing voltage is applied to the address electrode A₂. Then, as shown in FIG. 9C, the Y electrode Y₂ on the next line is put into a writable state. The switching device S₂ in the address driver circuit 201 connected with the address electrode A₂ is turned on. In consequence, an addressing voltage, for example, at H level as shown is applied to the address electrode A₂. At this time, the switching device S₁ connected with the address electrode A₁ is turned off. The addressing voltage from the switching device S₁ goes low (L). That is, no addressing voltage is applied to the address electrode A₁. If the same image appears repeatedly, the switching devices are turned on and off repeatedly in a corresponding manner.

Where a certain pattern image such as a white noise image or white noise-like pattern image is displayed in this way, the plural switching devices Sⱼ in the address driver circuit 201 performs a very large number of switching operations, increasing the switching loss of the switching devices. The address driver circuit 201 is designed to output an addressing voltage of a given voltage (e.g., 60 to 100 V). If the switching loss is increased, the electrical current necessary to obtain a given voltage is increased accordingly. As a result, the address current supplied from the power supply circuit to the address driver circuit 201 increases, thus increasing the power consumption. Hence, the amount of heat generated by the address driver circuit 201 increases.

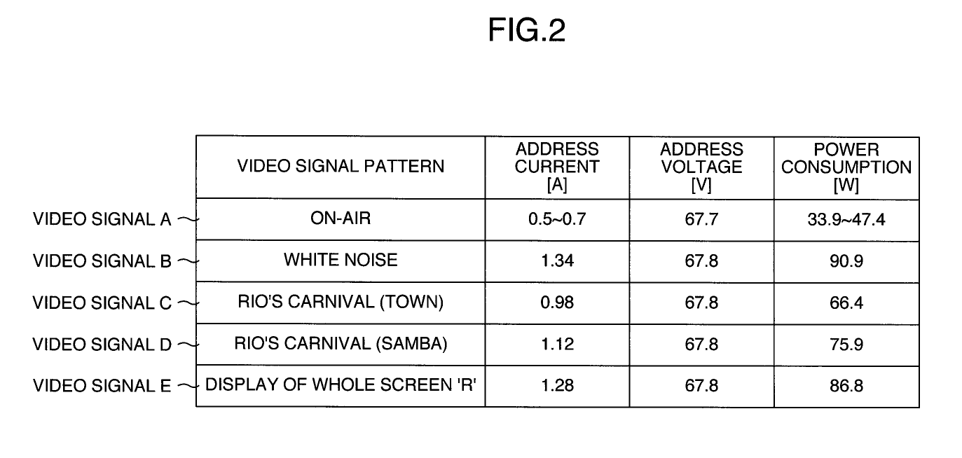

The relationships of the kinds (patterns) of video signals to increases in address current and power consumption based on the above-described principle are described while showing examples of their actual measurement values by referring to FIG. 2, which depicts the relationships among address current, addressing voltage, and power consumption for different video signal patterns.

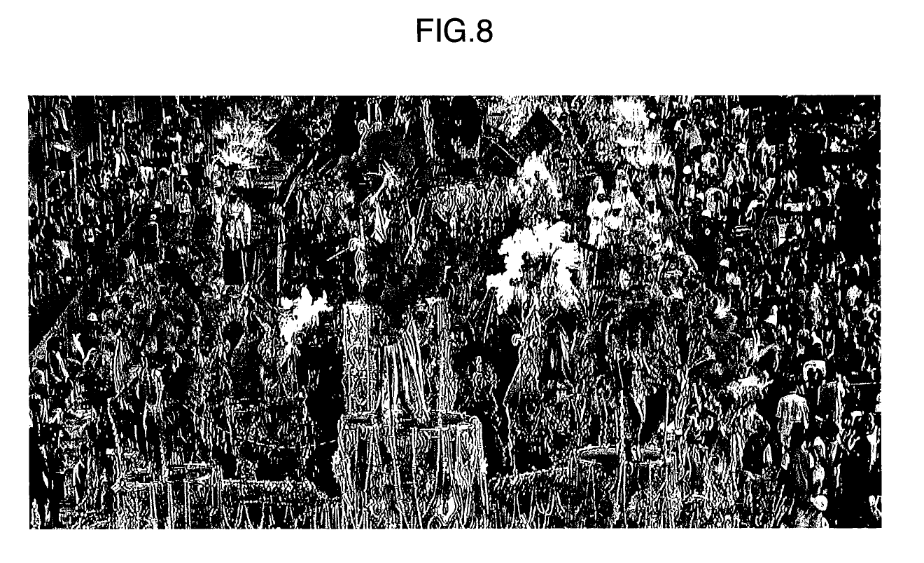

In FIG. 2, video signal A is a normal on-air image other than certain image patterns. Video signals B-E indicate signals of certain video patterns. The video signal B is a white noise image. The video signal C is, for example, an image of a scene of a town where Rio's Carnival is performed. The video signal D is an image of people who are playing a samba in the Rio's Carnival. The video signal E is a frame of totally black image in which small (e.g., 20 dots×20 dots) white characters R are aligned. The video signals C-E are white noise-like pattern images each, for example, having a hounds'-tooth image pattern in which bright and darks spots are minutely scattered. One example of white noise-like pattern image is shown in FIG. 8, which is an image of people who are playing a samba in Rio's Carnival (video signal D).

As can be seen from FIG. 2, the address current obtained when the video signal B being a white noise image is entered is 1.34 A, which is much greater than address currents of 0.5 to 0.7 A produced when the video signal A that is a normal on-air image (image other than certain image patterns) is entered. As shown in FIG. 2, when the video signal C that is a white noise-like pattern image is entered, the address current is 0.98 A. When the video signal D is entered, the address current is 1.12 A. When the video signal E is entered, the address current is 1.28 A. These video signals result in address currents much greater than where the video signal A being a normal on-air image is entered, in the same way as the video signal B, because when a white noise image or white noise-like pattern image is entered, the number of switching operations of the address driver circuit 201 increases to thereby increase the switching loss, thus increasing the address current. At this time, the addressing voltage is constant and so the power consumption of the address driver circuit is much greater than in the case of the video signals A (33.9 to 47.4 W) as shown in FIG. 2. For example, in the case of the video signal B, the power consumption is 90.9 W. In the case of the video signal E, the power consumption is 86.8 W. That is, the power consumption is nearly doubled compared with the case of the video signal A. As a result, the temperature of the outermost surface of the PDP on the viewer side near the address driver circuit rises. As shown in FIG. 2, there is a great difference in address current value between a normal on-air image and a white noise image or white noise-like pattern image. Accordingly, in the present embodiment, a normal on-air image is discriminated from a white noise image or white noise-like pattern image by detecting the address current. Conventional methods of detecting white noise images are described, for example, in JP-A-7-192205, JP-A-2008-160231, and JP-A-2006-133405. In these methods, white noise images are detected depending on whether there is a synchronization signal. Where a white noise-like pattern image having a synchronization signal is entered, none of such conventional methods can be applied. However, in the present embodiment, white noise-like pattern images can be discerned, as well as white noise images, by detecting the address current.

The present embodiment is hereinafter described in further detail including control provided to reduce the power consumption of an address driver circuit associated with the present embodiment.

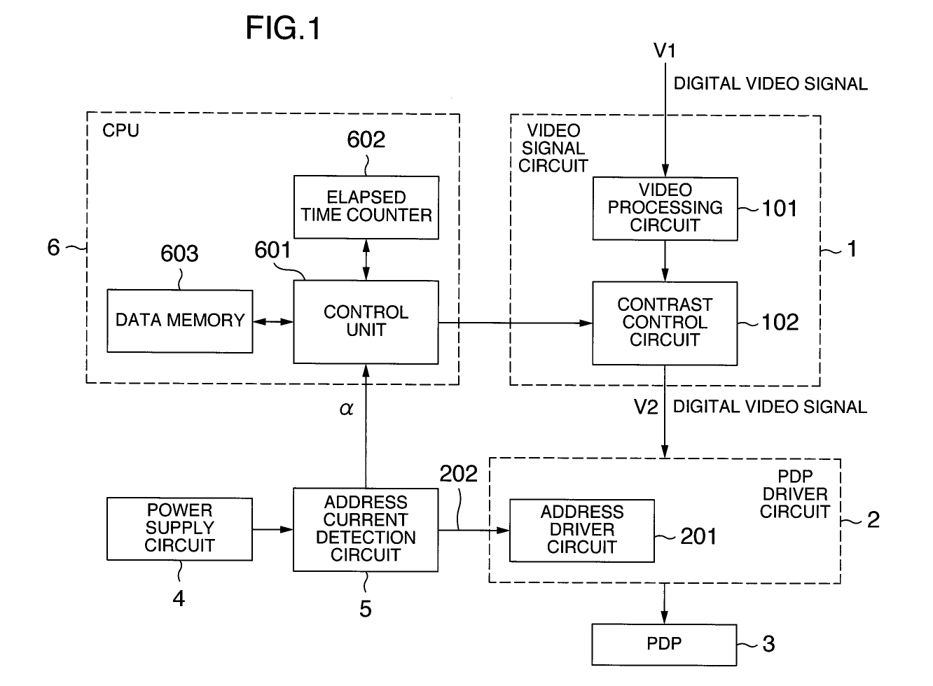

FIG. 1 is a block diagram of a PDP display apparatus according to the present embodiment. In FIG. 1, the PDP display apparatus consists principally of a video signal circuit 1 performing given processing (e.g., a gamma correction operation, operation for black level correction, and, if necessary, interfaced/progressive conversion and frame rate conversion), on an input digital video signal V1, a PDP 3 that is a display panel, a PDP driver circuit 2 for controlling operation of the PDP 3 based on a digital video signal V2 output from the video signal circuit 1, a power supply circuit 4 for supplying electric power necessary to drive the PDP 3, an address current detection circuit 5 for detecting the address current supplied to the PDP driver circuit 2 from the power supply circuit 4, and a central processing unit (CPU) 6 for controlling the whole PDP display apparatus and controlling the video processing performed by the video signal circuit 1 based on the address current detected by the address current detection circuit 5.

Furthermore, the video signal circuit 1 includes a video processing circuit 101 for correcting the image quality and a contrast control circuit 102 for determining the contrast.

The PDP driver circuit 2 includes an address driver circuit 201 for determining positions at which pixels are lit up. The CPU 6 is designed to include a control portion 601, an elapsed time counter 602, and a data memory 603 for storing contrast-controlling data used in controlling the contrast control circuit 102. The control portion 601 controls the contrast control circuit 102 based on the address current 202 through the address driver circuit 201, the current 202 being detected by the address current detection circuit 5. The elapsed time counter 602 counts the time for which the address current 202 is in excess of a given value α. It is here assumed that the given value α is an address current value providing a basis in discriminating a normal on-air image from a white noise image or white noise-like pattern image. As an example, it is assumed that α=0.9 A (amperes). The address current is its average current value. For example, the average current is the average value of address currents taken over one subfield/frame or over one video field/frame. According to the need, the average current is the average value of address currents taken over several to tens of frame fields. In order to detect the average current, an integrator circuit, for example, may be incorporated in the address current detection circuit 5.

Flow of the video signal shown in FIG. 1 is next described. In a normal PDP display apparatus, if the digital video signal V1 is entered to the video signal circuit 1, the video processing circuit 101 performs image quality correction such as brightness adjustment. The digital video signal undergone the image quality correction is output to the contrast control circuit 102. In the contrast control circuit 102, the contrast of the digital video signal output from the video processing circuit 101 is adjusted to an appropriate value, and the digital video signal V2 is output to the PDP driver circuit 2. In the PDP driver circuit 2, an image is displayed on the PDP 3 based on the digital video signal V2 output from the video signal circuit 1.

At this time, in the PDP display apparatus according to the present embodiment, the address current detection circuit 5 constantly detects the value of the address current 202 (hereinafter referred to as the address current value) that is the power supply current (average current) supplied from the power supply circuit 4 to the address driver circuit 201 included in the PDP driver circuit 2. The power supply circuit 4 also supplies electric power to a sustain-drive circuit (not shown) and a scan-sustain-drive circuit (not shown) included in the PDP driver circuit 2. The address current value detected by the address current detection circuit 5 is entered to the control portion 601 included in the CPU 6.

The control portion 601 inside the CPU 6 makes a decision as to whether the value of the address current entered from the address current detection circuit 5 is in excess of the given value α providing a basis in the decision making in order to discern white noise images or white noise-like pattern images that are certain pattern images.

If the control portion 601 of the CPU 6 has determined that the address current value detected by the address current detection circuit 5 exceeds the given value α, the control portion counts the elapsed time for which the given value α (e.g., 30 minutes as described later) is exceeded, using the elapsed time counter 602.

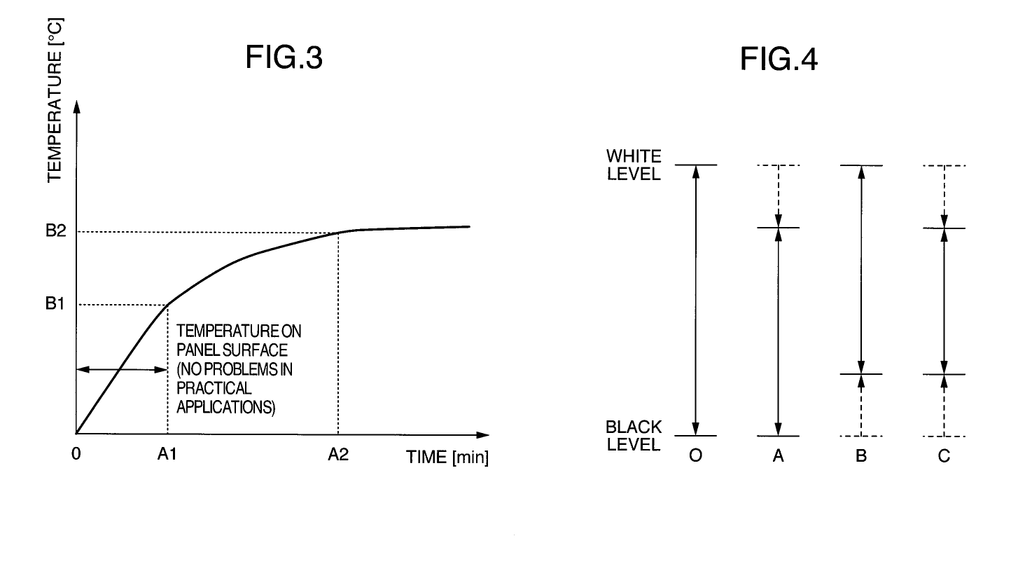

FIG. 3 shows timewise variations of the temperature of the outermost surface of the PDP on the viewer side when a white noise image is entered. In FIG. 3, the horizontal axis indicates the time, while the vertical axis indicates the temperature of the outermost surface of the PDP on the viewer side near the address driver circuit. When a white noise image, for example, is entered to the PDP display apparatus, the address current value assumes a high value exceeding the given value α. This increases the power consumption of the address driver circuit 201. Therefore, the temperature of the outermost surface of the PDP 3 on the viewer side near the address driver circuit 201 rises gradually as shown in FIG. 3. Where a video signal (such as a white noise image or white noise-like pattern image) is entered to the address driver circuit 201 continuously for more than a given period such that the address driver circuit 201 operates in such a way that the address current 202 is in excess of the given value α, the temperature of the outermost surface of the PDP 3 on the viewer side near the address driver circuit 201 locally exceeds a certain temperature (e.g., 60° C.) that is felt hot when touched.

In FIG. 3, A1 indicates a time (e.g., 10 minutes) for which the temperature of the outermost surface of the PDP 3 on the viewer side near the address driver circuit 201 is allowed to drop and reaches a practically acceptable temperature B1 (e.g., 50° C.) when a video signal is entered such that the address current 202 as produced by a white noise image exceeds the given value α. A2 indicates a time (e.g., 30 minutes) for which the temperature of the outermost surface of the PDP 3 on the viewer side near the address driver circuit 201 is allowed to vary and reaches a temperature B2 (e.g., 60° C.) at which the temperature almost becomes saturated at the tangibly hot temperature. In the following description, the elapsed time since the address current has exceeded the given value α may be simply referred to as the “elapsed time”.

Accordingly, in the present embodiment, if the time for which the given value α providing the decision criterion is exceeded continuously is longer than the time A2, the address driver circuit 201 is controlled such that its power consumption is reduced, in order to enhance the safety. That is, it can be seen from FIG. 3 that if the elapsed time counted by the elapsed time counter 602 is the time A1, for example, at the temperature B1, neither the temperature of the outermost surface of the PDP on the viewer side nor the image is affected. Therefore, the control portion 601 in the CPU 6 does not output the contrast control signal to the contrast control circuit 102. On the other hand, where the elapsed time counted by the elapsed time counter 602 is equal to or longer than the time A2 (e.g., 30 minutes), for example, at the temperature B2, the temperature of the outermost surface of the PDP 3 on the viewer side and the image are affected. Therefore, the control portion 601 in the CPU 6 outputs the contrast control signal to the contrast control circuit 102 in order to reduce the power consumption of the address driver circuit 201. At this time, the control portion 601 in the CPU 6 fetches contrast control data for reducing the power consumption of the address driver circuit 201 based on the present contrast control data from the data memory 603 and outputs the contrast control signal to the contrast control circuit 102 in the video signal circuit 1. The contrast control circuit 102 controls and lowers the contrast of the digital video signal V1 entered to the video signal circuit 1 based on the contrast control signal from the control portion 601.

The elapsed time may be measured continuously since the address current detected by the address current detection circuit 5 has exceeded the given value α. However, in some cases, white noise-like pattern images may appear intermittently with interruption times, for example, of about 0.5 to several seconds (e.g., the video signal A is inserted) over a given period (e.g., 30 minutes). During the interruption times, the temperature of the address driver circuit 201 does not drop immediately. Therefore, the elapsed time counter 602 does not immediately clear its count value when the address current becomes, for example, below the given value α. The counter holds the count value, for example, for several seconds to tens of seconds. Then, if the address current exceeds the given value α, the counting may be started from the held value.

In the present embodiment, in a case where the address current exceeds the given value α for a given time (this case may be referred to as the state of increased address current), a control operation is performed to lower the contrast for the following reason. As an example, it is assumed that a certain video pattern has a large number of tiny white bright spots present against a black background and that the video grayscale is represented by 8 bits. That is, the lowest gray level (black) is indicated by 0. The highest gray level (white) is indicated by 255.

In this video signal, if a gray level that is close to black and corresponds, for example, to a black background is controlled to be 10 and a gray level that is close to white and corresponds to white tiny bright spots is controlled to be 240 in order to lower the contrast, the lowest gray level (black portions of gray level 0) and the highest gray level (white portions of gray level 255) do not appear in one video field. Accordingly, in one subfield (e.g., the first subfield) close to the dark end of the grayscale, all the pixels (discharge cells) are activated to emit light. During this first subfield, the switching devices in the address driver circuit 201 do not perform switching operation. On the other hand, during one subfield (e.g., the last subfield) close to the bright end of the grayscale, none of the pixels (discharge cells) are activated. During this last subfield, the switching devices in the address driver circuit 201 do not perform switching operation. That is, it is possible to create subfields in which no switching operation is performed or the number of switching operation is reduced or to increase the number of such subfields by controlling the contrast so as to lower it. That is, according to the present embodiment, when the address current has been increased, the number of switching operations can be reduced compared with the case where the contrast is not reduced if the same image is displayed, by controlling the contrast.

In this way, in the state where the address current has been increased, if the contrast is controlled and lowered, the number of switching operations can be reduced during the period of one video field/frame. Concomitantly, the switching loss can be reduced. In this case, the power consumption of the address driver circuit can be reduced.

It is conceivable that the contrast control for reducing the power consumption of the address driver circuit 201 assumes plural control patterns which are shown by way of examples in FIG. 4. In FIG. 4, the leftmost portion O schematically illustrates the contrast produced before the address driver circuit is controlled such that its power consumption is reduced.

One conceivable method of lowering the contrast using a contrast control pattern is to lower only the white level (peak level of video signal) as shown at A in FIG. 4. Another conceivable method is to increase only the black level as shown at B of FIG. 4. A further conceivable method consists of lowering the white level (peak level of video signal) and, at the same time, increasing the black level as shown at C of FIG. 4. Any one of the control patterns may be used or they may be used in combination according to the need. Consequently, the video signal output to the PDP which indicated white and black represents (1) gray and black, (2) white and gray, or (3) gray and gray. This increases the number of unlit pixels or lit pixels as mentioned previously. The number of address switching operations (number of addressing discharges) per field decreases. Hence, the address current 202 can be reduced. If the amount by which the contrast is reduced, the amount by which the peak level is reduced, or the amount by which the black level is increased (these amounts are collectively referred to as the controlled value), the number of switching operations will be reduced more effectively. However, the felt contrast decreases accordingly and the image becomes unclearly visible. Accordingly, the controlled value is preferably set to several percent to about 10% of the total number of gray levels. For example, in the case where there are 255 gray levels, it is desired to set the controlled value to about 5 to 10 gray levels. In the present embodiment, the contrast is controlled, for example, by controlling the gain of a digital amplifier that amplifies the digital video signal. For example, it is assumed that the gain under normal state is 1. Where the address current exceeds the given value α for a given period, the gain is set to 0.9. The control method is not limited to controlling the gain of the digital amplifier. Alternatively, when the address current has been increased, the black level may be increased by a black level correction circuit. Yet alternatively, when the address current has been increased, the peak level of the video signal may be limited or reduced by a peal limitation circuit or gamma correction circuit.

That is, the video signal circuit 1 (particularly, the contrast control circuit 102) performs an operation (e.g., contrast control) for reducing the average value of the address current under control of the CPU 6, thus reducing the power consumption of the address driver circuit 201.

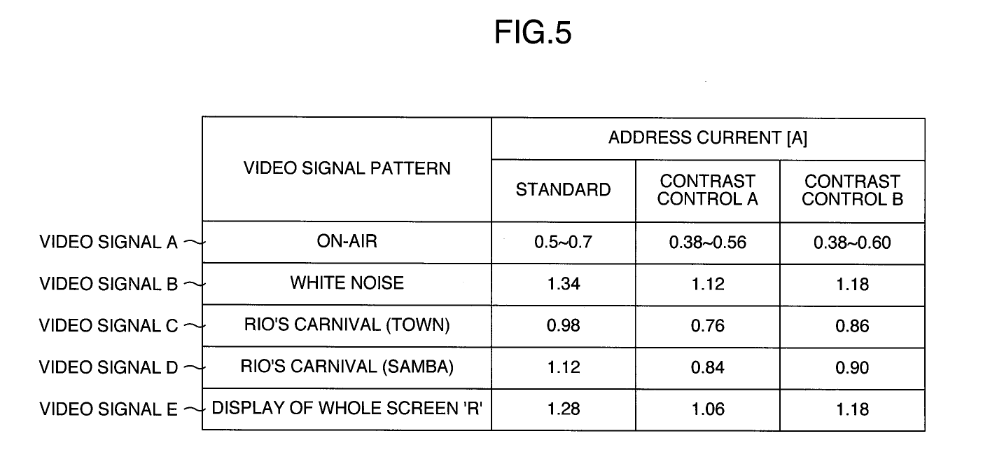

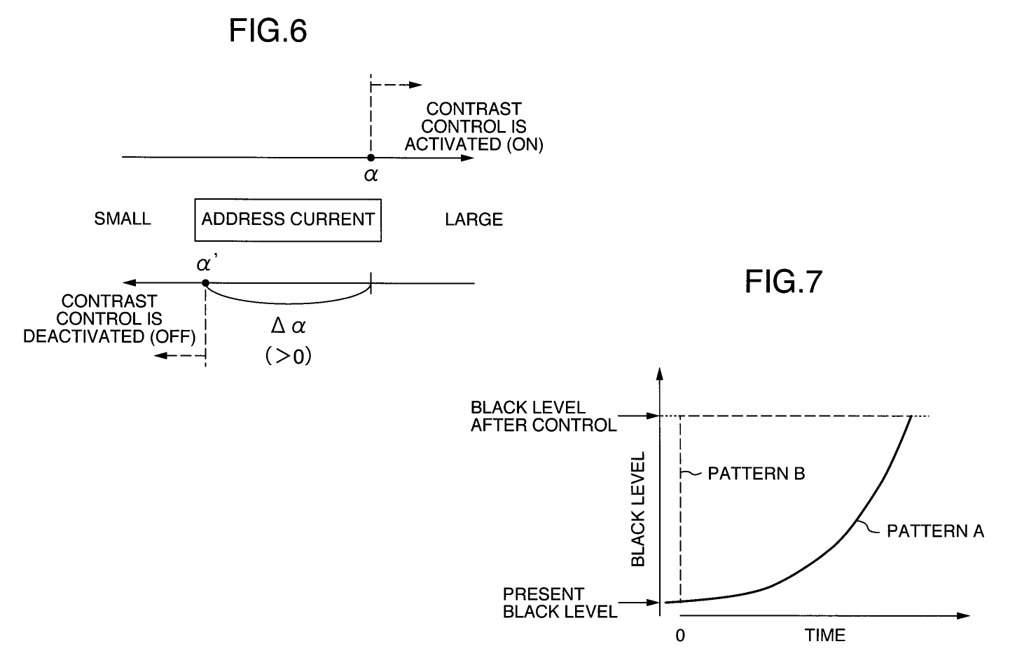

FIG. 5 shows variations of the address current 202 in cases where the contrast control A and contrast control B are applied to each video signal pattern. It can be seen from FIG. 5 that the address current 202 of the address driver circuit 201 can be reduced by controlling the contrast of the digital video signal V1. FIG. 6 is a diagram illustrating the relationship between the given value α used in providing contrast control and another given value α′ at which the contrast control is ceased. Where a certain pattern image is entered, the address current value assumes a high value in excess of the given value α. The temperature of the outermost surface of the PDP on the viewer side near the address driver circuit 201 rises and so the control portion 601 provides contrast control via the contrast control circuit 102. Immediately after the contrast control is provided, even if the address current value of the address driver circuit 201 detected by the address current detection circuit 5 is below the given value α, the temperature of the outermost surface of the PDP on the viewer side near the address driver circuit 201 does not drop immediately. Therefore, it is necessary to continue the contrast control. Accordingly, as shown in FIG. 6, the contrast control is continued, even if the address current value is below the given value α immediately after the contrast control is provided, by setting the contrast control in such a way that the control is stopped when the address current value is below the given value α′ (<α). This assures that the temperature of the outermost surface of the PDP on the viewer side near the address driver circuit 201 drops. In this embodiment, the relationships α=0.9 A and α′=0.7 A are introduced as an example by referring to FIG. 5.

Where a normal on-air image is entered while the contrast control is being provided, the address current value certainly becomes lower than the given value α′ as can be seen from FIG. 5. Therefore, the contrast control can be stopped.

In this way, when a white noise image or white noise-like pattern image is entered, the power consumption of the address driver circuit 201 can be reduced. Consequently, the amount of heat generated by the address driver circuit 201 is suppressed. Increases in the temperature of the outermost surface of the PDP on the viewer side near the address driver circuit 201 can be suppressed.

As described previously, according to the present embodiment, white noise images and white noise-like pattern images can be discerned by detecting the address current 202 of the address driver circuit 201 by means of the address current detection circuit 5 and counting the elapsed time for which the value of the address current 202 detected by the elapsed time counter 602 in the CPU 6 is in excess of the given value α. Where an input image can be discriminated from white noise images and white noise-like pattern images, the address current 202 can be reduced by controlling the contrast. As a result, increases in the temperature of the outermost surface of the PDP 3 on the viewer side near the address driver circuit 201 can be suppressed. Where a normal on-air image resulting in an address current value lower than the given value α′ (<α) is entered while the contrast is being controlled, the contrast control can be stopped.

Where the PDP display apparatus has a depthwise dimension of about 100 mm, for example, a space where convection flow of air occurs can be formed either around the address driver circuit or between the back cover and the address driver circuit. Heat generated by the address driver circuit can be dissipated to the outside through the space. However, if the depthwise dimension of the PDP display apparatus is reduced, for example, to 50 mm or less, the address driver circuit, panel, and back cover are mounted close to each other and so it is difficult to secure the space for convention flow of air. Furthermore, the heat generated by the address driver circuit is transmitted to the PDP more easily. That is, in the case of a thin PDP display apparatus, it is difficult to lower the temperature of the outermost surface of the PDP on the viewer side. However, if the control method associated with the present embodiment is applied, the temperature of the address driver circuit and the temperature of the outermost surface of the PDP on the viewer side can be desirably lowered.

That is, the present embodiment is adapted to be applied to thin PDP display apparatus having a depthwise dimension equal to or less than 50 mm. Of course, the present embodiment can be applied to apparatus having a depthwise dimension of about 100 mm.

The pattern in which the white level and black level are varied in controlling the contrast as described so far can be varied variously. Patterns in which the black level is varied are illustrated in FIG. 7. For example, as in pattern A indicated by the solid line in FIG. 7, the black level may be varied mildly with time. As in pattern B indicated by the dashed line in FIG. 7, the black level may be varied rapidly with time. Other various changes and modifications may also be made without departing from the gist of the present invention.

It should be further understood by those skilled in the art that although the foregoing description has been made on embodiments of the invention, the invention is not limited thereto and various changes and modifications may be made without departing from the spirit of the invention and the scope of the appended claims.

1. A plasma display panel display apparatus adapted to display an image using a plasma display panel, said plasma display panel display apparatus comprising:
an address driver circuit for performing an addressing operation for selecting some of discharge cells to be activated to emit light in response to an input video signal from discharge cells formed in the plasma display panel;
a current detection circuit for detecting an address current flowing through the address driver circuit; and
a control circuit for reducing the address current when the address current detected by the current detection circuit continues to be in excess of a given value for a given period of time.

2. A plasma display panel display apparatus as set forth in claim 1, wherein said current detection circuit detects an electrical current flowing from a power supply circuit to said address driver circuit as said address current, said power supply circuit acting to supply electric power to the address driver circuit.

3. A plasma display panel display apparatus as set forth in claim 1, wherein the image is displayed on the plasma display panel by dividing each frame/field of the input video signal into plural subfields and performing said addressing operation for each of the subfields, and wherein said current detection circuit detects an average value of said address current produced concomitantly with said addressing operation performed in one subfield period.

4. A plasma display panel display apparatus as set forth in claim 1, wherein said current detection circuit detects an average value of said address current taken over a given time.

5. A plasma display panel display apparatus as set forth in claim 1, wherein there is further provided a contrast control circuit for controlling the contrast of said input video signal, and wherein when said address current detected by said current detection circuit continues to be in excess of the given value for a given period, said control circuit controls said contrast control circuit to thereby lower the contrast of said input video signal, thus reducing the address current.

6. A plasma display panel display apparatus as set forth in claim 1, wherein there is further provided a video processing circuit for controlling a black level of said input video signal, and wherein when said address current detected by said current detection circuit continues to be in excess of the given value for a given period, said control circuit controls the video processing circuit so as to increase the black level of the input video signal, thus reducing the address current.

7. A plasma display panel display apparatus as set forth in claim 1, wherein there is further provided a video processing circuit for controlling a black level of said input video signal, and wherein when said address current detected by said current detection circuit continues to be in excess of the given value for a given period, said control circuit controls the video processing circuit so as to reduce a peak level of the input video signal, thus reducing the address current.

8. A plasma display panel display apparatus adapted to display an image using a plasma display panel, said plasma display panel display apparatus comprising:
an address driver circuit for performing an addressing operation for selecting some of discharge cells to be activated to emit light in response to an input video signal from discharge cells formed in the plasma display panel; and
a control circuit which makes a decision as to whether said input video signal is a white noise image or a white noise-like pattern image and which, when the white noise image or the white noise-like pattern image persists for a given period, reduces said address current.

9. A plasma display panel display apparatus as set forth in claim 8, wherein said control circuit determines that said input video signal is a white noise image or a white noise-like pattern image in a case where the address current through said address driver circuit exceeds a given value.

10. A plasma display panel display apparatus as set forth in claim 8, wherein when said white noise image or white noise-like pattern image persists for a given period, said control circuit lowers the contrast of the input video signal, thus reducing said address current.

11. A plasma display panel display apparatus as set forth in claim 8, wherein when said white noise image or white noise-like pattern image persists for a given period, said control circuit increases a black level of the input video signal, thus reducing said address current.

12. A plasma display panel display apparatus as set forth in claim 8, wherein when said white noise image or white noise-like pattern image persists for a given period, said control circuit reduces a peak level of the input video signal, thus reducing said address current.
